(19) United States
(12) Patent Application Publication
(10) Pub. No.: US 2012/0041708 A1
(43) Pub. Date: Feb. 16, 2012

(54) METHOD AND SYSTEM FOR COUNTING STACKED ITEMS

(76) Inventor: Jacob Rutti, Bale (CH)

(21) Appl. No.: 13/206,931

(22) Filed: Aug. 10, 2011

(30) Foreign Application Priority Data
Aug. 10, 2010 (FR) 1056533

(51) Int. Cl. G06F 15/00

(52) U.S. Cl. 702/128

(57) ABSTRACT

The present method proposes, according to a first aspect, a method for counting stacked items forming on one side of the stack at least one level variation lineformed by the edges of the stacked items. The method includes the telemetric measurement of a variation in level on a line of points traversing the whole side of the stack and recording a corresponding raw signal. The method subsequently includes analysing the raw signal in order to estimate one or more parameters relating to the structure of the stack, followed by processing the raw signal in one or more statistical processing operations on the basis of the estimated parameters, and analysing the processed signal in order to determine the number of stacked items.

### CROSS-REFERENCE TO RELATED APPLICATIONS

The present application claims priority from French Patent Application No. 10/56533, filed Aug. 10, 2010. The contents of the priority application are hereby incorporated by reference in their entirety.

### BACKGROUND OF INVENTION

1. Field of the Disclosure

The present invention relates to the non-contact counting of stacked items and applies more particularly to the counting of letters.

2. Description of the Related Art

Devices are known for counting thin media sheets by illuminating the edge of a plurality of sheets with an LED network, as described in European patent application EP-A2-0743616 for counting packets of photographs. In a device of this type, a network of CCD cameras receives the light reflected by the sheets and generates a signal in the form of a wave corresponding to the variations in intensity of the reflected light.

Other non-contact counting systems are also known for counting envelopes and magazines, as described, for example, in the U.S. Pat. No. 4,384,195 and U.S. Pat. No. 5,221,837.

However, the growing number of distinctive features on letters and a reduced volume of mail cause letters collected in a stack to be counted to become more heterogeneous. The counting methods mentioned are therefore faced with a variety of technical challenges such as taking into consideration the presence of reflective envelopes, envelopes which are stuck together, envelopes which have not been arranged uniformly in the stack, fanned envelopes, envelopes of different sizes, damaged envelopes, etc. The existing counting methods are mainly intended for counting homogeneous items and these methods are rendered unsatisfactory by the abovementioned problems.

The present invention discloses a method and a system for counting stacked items which, in particular, offer excellent reliability in the counting of stacked items, even in cases where the said items are in the form of a heterogeneous stack.

### SUMMARY OF INVENTION

To this end, the invention provides in a first aspect a method for counting stacked items forming at least one level variation line on one side of the stack. The method comprises telemetric measurement of a variation in level on a line of points traversing the side of the stack, and recording a corresponding raw signal. The method subsequently comprises analysing the raw signal in order to estimate one or more parameters relating to the structure of the stack, followed by processing the raw signal in one or more statistical processing operations on the basis of the estimated parameters, and analysing the processed signal in order to determine the number of stacked items.

In particular, the present invention records the telemetric signal relating to the whole stack, and analyses the said signal in order to assess the structure of the stack before the signal is processed. This makes it possible to obtain data on the stack of items, for example to identify any inhomogeneity, so that an appropriate processing operation can be applied.

The present method allows customized processing of the raw signal and improves the reliability of the counting of items in inhomogeneous stacks. Counting performed on the basis of a raw signal from a measurement signal recorded over the entire width of the side proves to be more reliable than counting performed using the methods from the prior art.

The method can comprise estimating a mean thickness of the items in the stack and a dispersion factor for the thicknesses of the items in the stack. This makes it possible to obtain data on the composition of the items in the stack.

The step in which the raw signal is processed advantageously comprises determining an interference threshold. The interference threshold can allow a spread limit to be defined, below which there is little likelihood of there being a peak in the raw signal corresponding to an item in the stack.

Advantageously, if the dispersion factor of the stack is less than a predetermined value, then the interference threshold is proportional to the product of the dispersion factor and the mean thickness. Alternatively, if the dispersion factor of the stack exceeds the said predetermined value, then the interference threshold is a function of a mean thickness of those items in the stack which have a smaller thickness than a limit thickness. The limit thickness can, for example, be determined on the basis of the dispersion coefficient and the first mean thickness, and the mean thickness of the thin items in the stack can be obtained by analysing the raw signal.

The present definition of the interference threshold makes it possible to take into consideration inhomogeneous stacks in which items of widely differing sizes may be present. Thus, when the dispersion factor is high, the interference threshold is a function of the thickness of the thinnest items so that the signal is processed with sufficient accuracy. This makes it possible for there to be no underestimating of the counting.

The mean thickness of the items in the stack is advantageously determined as a function of a gross number of stacked items which is estimated on the basis of the recorded raw signal. This makes it possible to minimize the calculations required to determine the mean thickness of the items in the stack.

According to one embodiment, the processing of the raw signal comprises eliminating interference peaks on the basis of the interference threshold. This makes it possible to eliminate interference peaks which do not correspond to items in the stack.

According to one embodiment, the step in which the recorded raw signal is processed comprises reconstructing interruptions on the basis of the slope of the signal before and after the interruption when the interruption is longer than the interference threshold. This makes it possible to reconstruct the signal accurately by preserving the slope of the signal at the edges of the interruption.

According to one embodiment, the step in which the recorded raw signal is processed comprises reconstructing interruptions on the basis of the value of the signal before and after the interruption when the interruption is shorter than the interference threshold. This makes it possible to reconstruct the signal simply when there is little likelihood of a peak corresponding to an item being hidden by the interruption.

According to one embodiment, the step in which the recorded raw signal is processed comprises filtering the signal using a moving average, the number of points of the signal on which the said moving average is calculated being determined on the basis of the interference threshold. This makes it possible to filter the signal taking into consideration the structure of the stack in order to limit deletion of peaks corresponding to an item.

The step in which the processed signal is analysed can comprise, for example, counting the number of changes in the sign of the derivative of the processed signal and/or counting the number of changes in direction of the processed signal point by point, and/or checking for the presence of stuck-together items in the stack on the basis of the recorded raw signal.

Several of these methods are advantageously employed so that the reliability of the counting can be improved.

According to an alternative embodiment, the recording step can comprise recording a plurality of raw signals corresponding to measurement of the variation in the level on one or more lines of points traversing the whole side of the stack. This recording can be performed using a plurality of range finders, a range finder comprising a plurality of beams, and/or by scanning the side of the stack a plurality of times. This also makes it possible to improve the reliability of the counting.

Each of the raw signals is advantageously recorded and processed and the convergence of the results of counting the stacked items which are provided by the plurality of processed signals is checked.

According to a second aspect, the invention relates to a device for counting stacked items comprising a telemetric measurement system suitable for measuring a signal corresponding to the variation in level of at least one line traversing a side of the stack formed by the said stacked items; data storage means which are suitable for recording the said signal; calculation means which are suitable for implementing the counting method according to the first aspect of the invention.

### BRIEF DESCRIPTION OF DRAWINGS

Other features and advantages of the invention will become apparent on reading the following description, illustrated by the following figures:

FIG. 1 shows a functional diagram of a triangulation range finder for counting envelopes.

FIG. 2 shows a device for counting stacked items according to an embodiment of the invention.

FIG. 3 is a schematic diagram of steps in a method for counting stacked items according to an embodiment of the invention.

FIGS. 4A and 4B illustrate an interference peak in a recorded raw signal according to an embodiment of the invention.

FIGS. 5A to 5D illustrate an interference interruption in a recorded raw signal according to an embodiment of the invention.

FIGS. 6A and 6B illustrate the reconstruction of an interruption in a recorded raw signal according to an embodiment of a signal processing step of the invention.

FIGS. 7A to 7C illustrate the reconstruction of an interruption in a recorded raw signal according to an embodiment of a signal processing step of the invention.

FIGS. 8A and 8B illustrate the reconstruction of an interruption in a recorded raw signal according to an embodiment of a signal processing step of the invention.

FIGS. 9A and 9B illustrate respectively a recorded raw signal and a processed signal according to an embodiment of the invention.

FIG. 10 illustrates a flow chart of the detection of stuck-together items in the stack according to an embodiment of the invention.

FIGS. 11A and 11B illustrate intermediate steps in the detection of stuck-together items in an embodiment of the invention.

### DETAILED DESCRIPTION

The present method relates to the non-contact counting of stacked items and more particularly to substantially flat items such as, for example, a magazine, an envelope, a banknote, a credit card, etc. The items are arranged in such a way that they form, on one side of the stack, at least one level variation line which can be detected telemetrically, for example using a laser range finder.

In the present application, an “edge” of the stacked item refers to a face of the item with a reduced surface area which extends in almost one dimension only. For example, a rectangular envelope comprises four edges within the sense of the present description.

A side of the stack of items is thus formed by a combination of edges of stacked items.

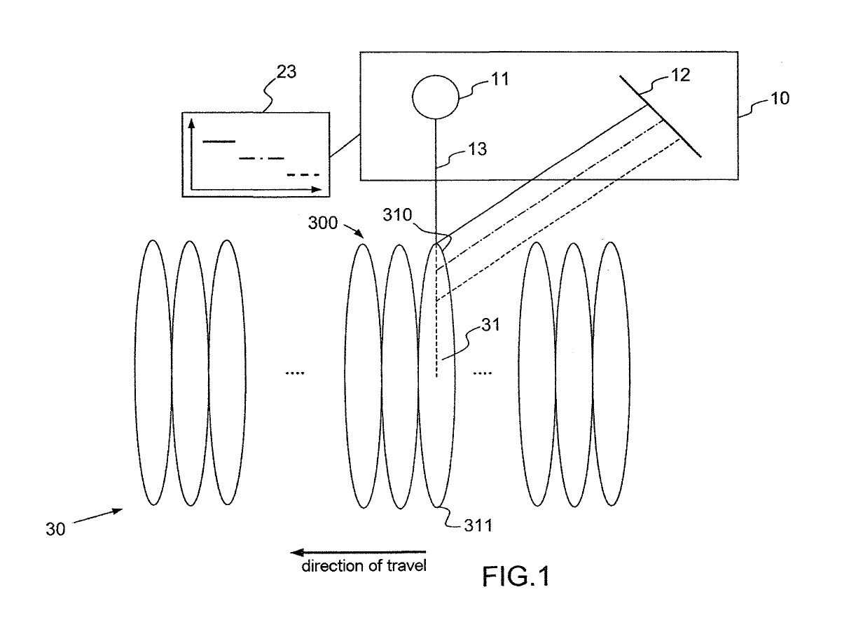

The general principle of a triangulation range finder applied to the counting of stacked items, for example envelopes, is detailed in the diagram in FIG. 1. A range finder 10 generally consists of an emission source 11 which emits a beam of light 13, for example a laser emission source, and a sensor 12, for example a CCD-type matrix sensor. The sensor is arranged so as to receive a beam reflected back by a side 300 of a stack 30 of items 31 which passes in front of the beam of light 13. The items 31 are arranged on one of their edges 311, in other words on a face of the item 31 with a reduced surface area which extends almost in one dimension only. The term side 300 of the stack 30 refers to one of the four faces of the stack 30 formed by edges 310 of the items 31 on which the beam of light 13 is reflected. For example, these may be the edges opposite the edges 311 on which the items are arranged.

The beam reflected back by the item 31 is received by the sensor 12. The sensor 12 supplies in response an electrical signal with a value which is a function of the position of a point of impact of the incident beam of light 13 on the item 31. Indeed, the position of the impact of the beam 13 on the item 31 is geometrically linked to the position of impact of the reflected-back beam on the sensor 12. The electrical signal supplied by the sensor can be viewed on a screen 23 and makes it possible to calculate the distance between the light source 11 and the point of impact on the item 31 of the incident beam 13 emitted by the light source 11.

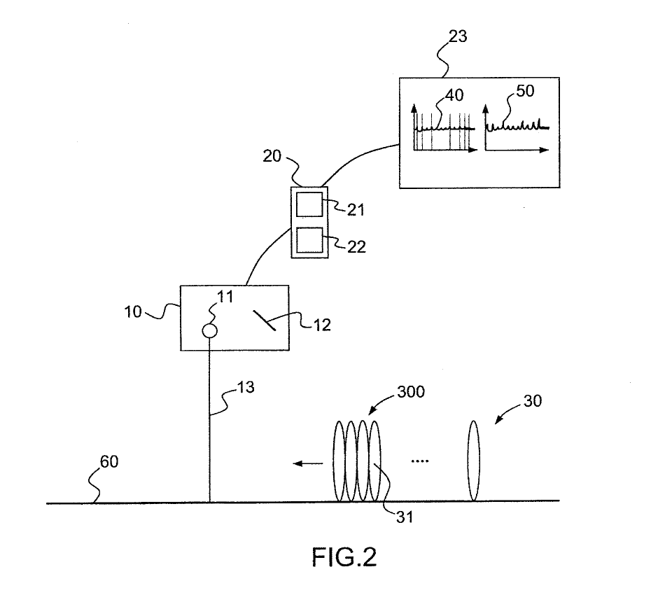

FIG. 2 illustrates a device for counting stacked items according to an embodiment of the invention. Similar parts in FIGS. 1 and 2 are denoted by the same reference numerals. The device comprises a range finder 10 comprising a light source 11 which emits a beam of light 13, for example a laser, and a sensor 12, for example a CCD matrix sensor. The sensor 12 is arranged to receive a beam reflected back by the side 300 of a stack 30 of items 31 which passes in front of the beam 13. The beam reflected back by the side 300 is received by the sensor 12. The sensor 12 supplies in response a raw electrical signal 40 which is transmitted to a computer system 20. The computer system 20 comprises a data storage unit 21, a computing unit 22 and a display unit 23. The computing unit 22 processes the raw signal 40 recorded in the storage unit 21 in order to obtain a processed signal 50 in a processing step of the method described in the following description. The raw signal 40 and/or the processed signal 50 can be viewed on the display unit 23.

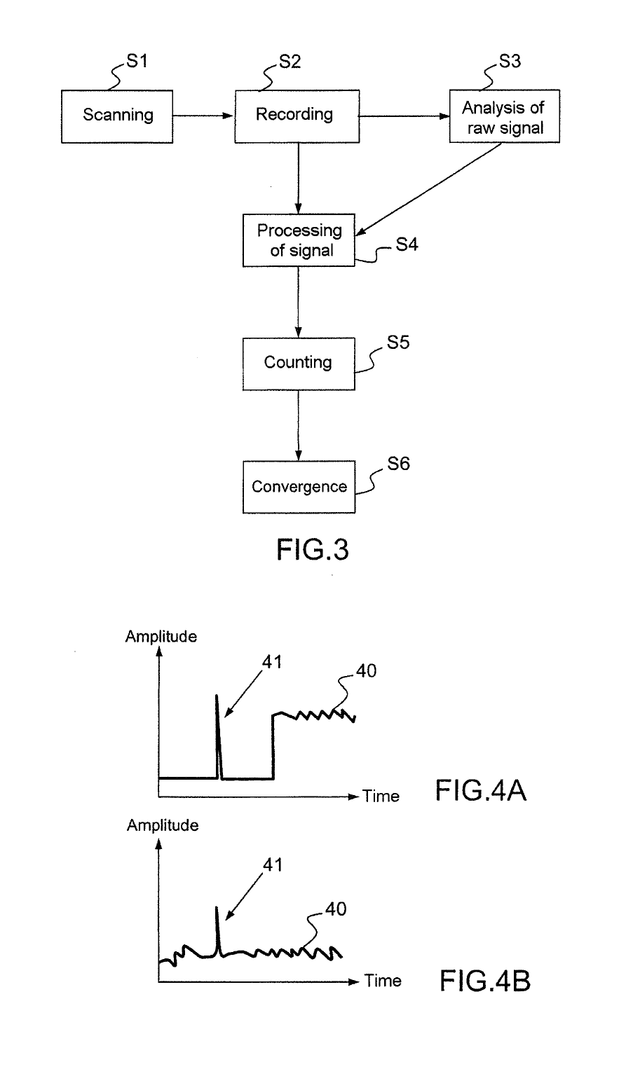

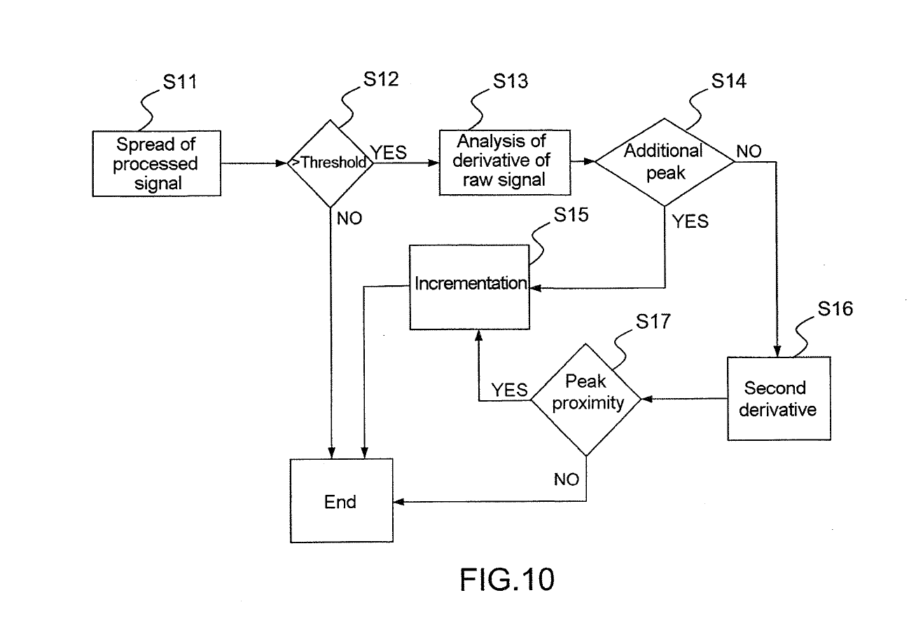

A counting method according to an embodiment of the invention is now described with reference to FIGS. 3 to 11. In a first step S1, the side 300 of the stack of items is scanned. The scanning is carried out in order to obtain a telemetric measurement on a line of points traversing the whole side 300 of the stack 30. In one embodiment, the range finder 10 has a fixed position and the stack 30 of items is moved relative to the range finder 10, for example using a conveyor belt 60. In another embodiment, the stack 30 of items is fixed and the range finder 10 is moved relative to the stack 30, for example using a carriage on rails on which the range finder 10 is mounted.

In a second recording step S2, the raw signal 40 output by the range finder 10 is recorded in the storage unit 21 of the computer system 20. The raw signal 40 is in the form of a timed reading of the amplitude of the measured electrical signal output by the sensor 12 during the scanning of the stack. The raw signal 40 corresponds directly to measurement of the variation in level of the line of points traversing the whole side 300 of the stack 30.

In what follows, the raw signal is considered to be a discrete signal with values over time which can be described by the values (X1 . . . Xn). A derivative of the raw signal can be determined between two consecutive clusters of N1 points with barycentres separated by N2 points using the formula:

$${X}_{k}^{′} = \frac{1}{{N}_{1} + {N}_{2}} ( \frac{1}{{N}_{1}} {\sum }_{p = 0}^{{N}_{1} - 1} {X}_{k + {N}_{1} + {N}_{2} + p} - {X}_{k + p} ) ,$$

where p, k, N1, N2 are whole numbers.

The derivative thus defined represents a slope between two means of N1 consecutive points of the signal which are separated by N2 points. In what follows, a derivative calculated point to point refers to a derivative calculation using the formula above in which the values of N1 and N2 are set at 1 and 0 respectively.

Moreover, the side 300 is formed by the edges 310 of the items 31 forming a level line or contour line. Consequently, the corresponding raw signal comprises peaks in amplitude. In what follows, the term “peak” is generally used to refer to the peaks in amplitude in the raw signal. The term “spread” of a peak refers to the maximum width of a peak in the raw signal. The spread of a peak corresponds to a measured thickness of an item 31.

In a third step S3 in which the raw signal is analysed, it is possible to determine a mean spread of the peaks, a dispersion factor of the spreads of the peaks relative to the mean spread, and a mean amplitude of the peaks. The processing in the remainder of the method can be adapted using these parameters relating to the structure of the stack. The mean spread of the peaks corresponds to the mean thickness of the items 31 of the stack 30 and can be determined by the quotient of the sum of the spreads of the peaks in the raw signal divided by the number of peaks. The dispersion factor of the spreads of the peaks relative to the mean spread can be calculated from the standard deviation of the spread of the peaks from the mean spread. The dispersion factor is an indicator of the inhomogeneity of the items 31 in the stack 30.

In a first embodiment, the mean spread of the peaks can be determined on the basis of an estimation of the number of stacked items (also referred to as the gross number in the following description). The gross number of stacked items can, for example, be estimated by counting the peaks in the raw signal. Such counting can, for example, be performed by analysing the derivative of the raw signal 40. More precisely, the counting of the peaks in the raw signal can be based on the count of the changes in the sign of the derivative of the signal, calculated point to point. The mean spread of the peaks in the raw signal can then be obtained by the quotient of the product of the thickness of the stack and a base resolution of the telemetric recording, divided by the gross number of items. The base resolution of the telemetric recording is, for example, defined by the quotient of a sampling frequency of the range finder, divided by the speed at which the side of the stack passes the range finder. The estimation step can be carried out using the computing means 22 of the computer system 20 connected to the range finder 10.

In a second embodiment, the mean spread of the peaks can be calculated from a fundamental frequency resulting from a spectral analysis of the raw signal, for example by breaking down the raw signal into a Fourier series and by establishing the mean frequency corresponding to the frequency at which the accumulated energy exceeds a threshold of 50% of the total energy of the spectrum. This mean frequency corresponds to a mean period of the letters. Given that the speed at which the side of the stack passes the range finder is constant, it can be used to calculate the mean thickness of the items 31.

The dispersion factor of the spreads of the peaks relative to the mean spread can be determined by the quotient of the standard deviation of the spread of the peaks and the mean spread.

In a fourth step S4 in which the signal is processed, the raw signal 40 is processed in one or more statistical processing operations on the basis of the parameters estimated from the raw signal. This makes it possible to improve the quality of the recorded signal. The processing step is performed on the basis of the recorded raw signal 40 corresponding to the whole side of the stack, taking into consideration the estimated structure of the stack. This makes it possible to process the raw signal with the inhomogeneity of the stack being taken into consideration, and to identify abnormalities in the raw signal. The applicant has shown that by processing the entire signal, measured over a whole line, a much more reliable count can be obtained, even with a stack of heterogeneous items.

The raw signal 40 can be processed by considering an interference threshold in the raw signal. The interference threshold represents a threshold below which the spread of a peak can be considered abnormal for a given stack. The interference threshold can result from observation of the stack of items by the user and from visually assessing the presence of thin items in the stack. By fixing the interference threshold, the processing operations of the raw signal can be adapted according to the stack of items so as to improve the quality of the signal without wrongly eliminating a peak corresponding to an item in the stack.

The interference threshold can advantageously be determined on the basis of the recorded raw signal. For example, if the dispersion factor is below a predetermined value, for example is between 0.4 and 0.5, the interference threshold can be proportional to the product of the mean spread of the peaks in the raw signal by the dispersion factor of the spread of the peaks. This makes it possible to take the disparity of the stacked items into consideration in the processing of the signal.

For example, with reference to the first embodiment for determining the mean spread, assuming that the sampling frequency f of the range finder is equal to 2000 points per second, the speed v at which the stacked items move relative to the range finder is equal to 0.1 m/s, the width D of the stack is equal to 0.5 m, the estimated gross number B of stacked items is equal to 623 and the dispersion factor σ is equal to 50%, the following interference threshold Sp is obtained:

$$Sp = \frac{D \times f}{B \times v} \times σ ≅ 8 points$$

Alternatively, when the dispersion factor is greater than the predetermined value, the low frequencies in the raw signal can be filtered and the interference threshold determined on the basis of a mean value for the spread of the peaks in the filtered raw signal. In other words, the interference threshold is then a function of a second mean spread calculated for the thinnest peaks with a thickness which is less than a limit thickness. The limit thickness can be determined on the basis of the first mean thickness and the dispersion factor. This makes it possible, in the event of a high degree of inhomogeneity among the items in the stack, not to ignore thin peaks corresponding to small-sized items in the stack. The limit thickness can be determined as a mean thickness of a portion of the thinnest letters. For example, the items can be sorted in order of increasing thickness and the mean thickness of the items can be taken for the thinnest 20%.

The signal processing step S4 comprises one or more statistical processing operations applied to the signal such as removal of interference peaks, removal of interruptions and fine filtering using a moving average.

A first processing operation can comprise the removal of interference peaks in the raw signal. FIGS. 4A and 4B illustrate the presence of an interference peak 41 in the raw signal 40 before the raw signal and within the raw signal, respectively. Such interference peaks can be caused by dazzling of the sensor 12 caused, for example, by an abnormal reflection of the beam of light. Envelopes made of reflective material, commonly used for promotional campaigns, can cause such dazzling. Specks of paper dust lying on the edge of the envelopes can also cause such dazzling. The interference peaks in the raw signal can be identified by comparing a value for the spread of the interference peak with a threshold, for example the interference threshold, and/or by comparing the value of the amplitude of the interference peak with the mean amplitude of the raw signal. Indeed, the interference peaks generally have a spread which is much less than the interference threshold and a very high amplitude, greater than the mean amplitude of the peaks. A speck of paper dust typically has a thickness of about 0.1 millimetre. Taking again the assumptions in the above example, an interference peak caused by the presence of a speck of dust generally has a thickness of 2 points.

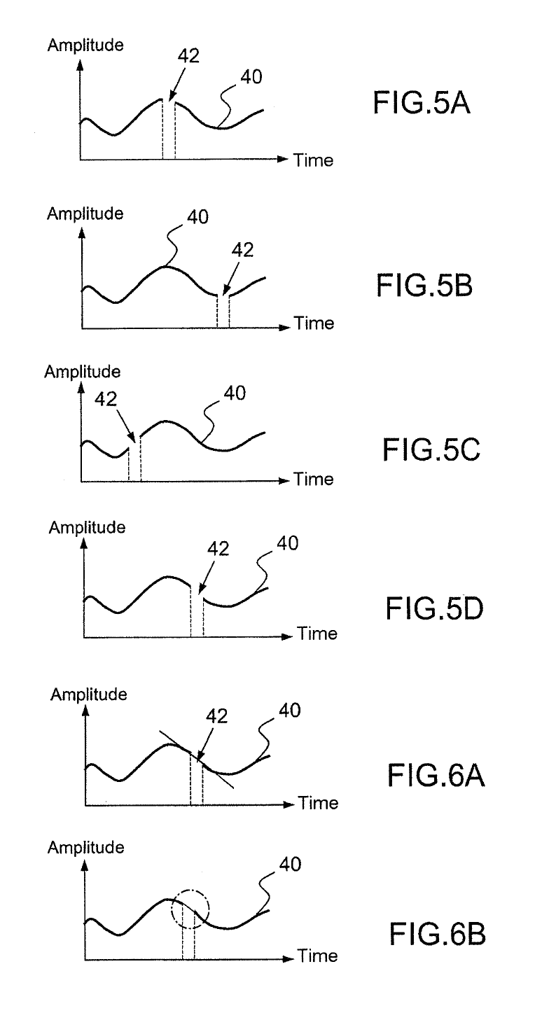

A second processing operation comprises the removal of the interruptions in the raw signal. FIGS. 5A to 5D illustrate interruptions 42 of the raw signal 40 which are positioned on a peak, in a trough, on the up slope of a peak and on the down slope of a peak of the signal, respectively. Such interruptions can be caused by the lack of any reflection, for example due to damage to the envelopes.

In a first embodiment of the removal of the interruptions, illustrated in FIGS. 6A and 6B, the interruption 42 is removed by reconstructing the raw signal 40 on the basis of the derivative of the signal, calculated between two clusters of N1 consecutive points separated by N2 points before and after the interruption. N1 can typically be chosen to be between 2 and 5 so as to limit the effect of the disturbances on the calculation. N2 is generally chosen to be close to the interference threshold. This processing operation makes it possible to provide quickly an approximation of the slope of the signal near the edges. This processing operation can advantageously be carried out when the size of the interruption 42 is greater than the interference threshold.

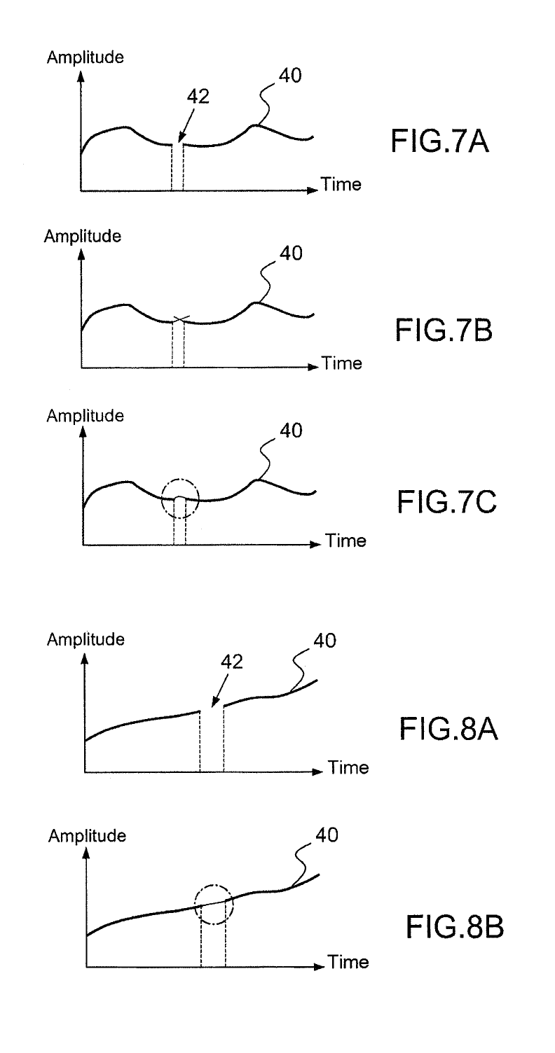

In a second embodiment of the removal of the interruptions, illustrated in FIGS. 7A-7C, the interruption 42 is removed by reconstructing the raw signal 40 on the basis of the derivative of the signal, calculated point to point before and after the interruption. This processing operation makes it possible to determine accurately the slope of the signal at the edges of the interruption 42. This processing operation can advantageously be carried out when the size of the interruption 42 is greater than the interference threshold.

In a third embodiment illustrated in FIGS. 8A and 8B, the interruption 42 is removed by reconstructing the raw signal 40 on the basis of the value of the signal before and after the interruption. This processing operation makes it possible to reconstruct the signal simply by a linear approximation of the signal. This processing operation can advantageously be carried out when the size of the interruption 42 is less than the interference threshold.

A third processing operation can comprise the fine filtering of the raw signal using a moving average. A mathematical formula for carrying out such a filtering operation can take the following form:

$$\overline{{X}_{n}} = \frac{1}{N} {\sum }_{p = 0}^{N} {X}_{n - p}$$

The choice of the number N of points of the signal on which the said moving average is calculated can be made on the basis of a threshold, for example the interference threshold determined in the step S3 in which the raw signal is analysed. In one embodiment, the number N can be chosen to be equal to half the interference threshold. This processing operation makes it possible to effect a low-pass filtering of the raw signal and to overcome the problem of microwaves.

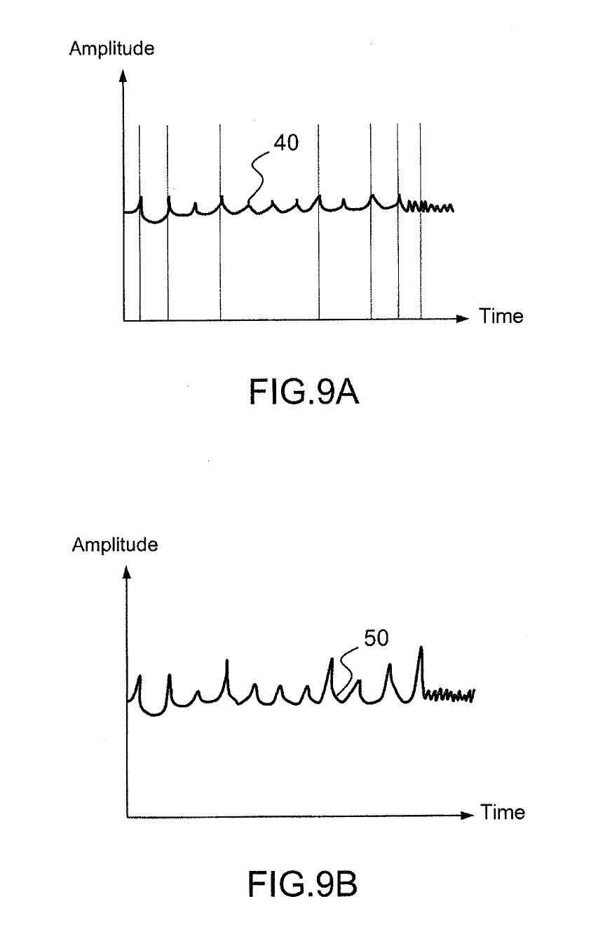

FIGS. 9A and 9B illustrate respectively a raw signal 40 and a processed signal 50 in an embodiment in which the signal processing step S4 comprises successively removal of the interference peaks, reconstruction of the interruptions and fine filtering using a moving average.

In a fifth counting step S5, the processed signal 50 is analysed in order to determine accurately the number of items 31 in the stack 30.

In a first embodiment of the counting step S5, the number of items 31 in the processed signal 50 is determined by serially analysing the derivative of the processed signal, calculated between two clusters of N1 consecutive points separated by N2 points. In this calculation, N1 can be chosen to be, for example, between 1 and 5 depending on how compact the stack is, and N2 can be chosen to be equal to the interference threshold. The closer together the items in the stack, the more N1 is generally chosen to be small. The analysis of the derivative comprises counting the number of changes in the sign of the derivative.

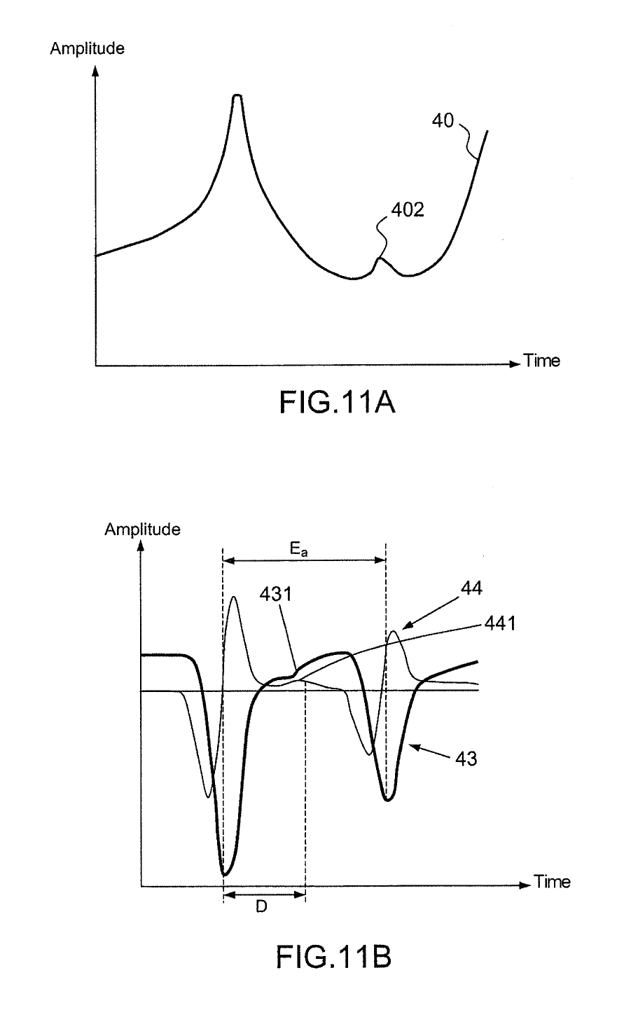

In a second embodiment of the counting step S5, illustrated in FIG. 11, in addition to determining the number of items on the basis of the serial analysis of the derivative of the processed signal, any stuck-together items in the stack are detected. This makes it possible to improve the counting of the items 31. Indeed, items in the stack may, for example, be damaged by an object falling onto the side 300 of the stack 30. The edges 310 of the damaged items may then form a virtually continuous flat line. The raw signal corresponding to such damaged peaks has a virtually constant amplitude.

In a first step S11 in which the stuck-together items are detected, the spread of the peaks in the processed signal 50 can be determined. For example, the spread of the peaks can be calculated by analysing the changes in the sign of the derivative of the processed signal 50. Indeed, a peak is bordered by two minima and analysing the derivative of the signal allows the spread of the peaks in the signal to be calculated. A device for implementing the detection of the stuck-together items can comprise a Schmitt trigger which is configured to switch when the derivative of the raw signal, supplied as an input to the trigger, changes sign. The trigger thus outputs a rectangular-wave signal and the width of the rectangular wave corresponds to the spread of the peaks of the processed signal.

In a step S12 in which the stuck-together items are detected, the spread of the peaks is compared with a threshold to determine the peaks liable to contain stuck-together items. The threshold can be equal to the interference threshold or the mean value of the spread in the raw signal. For a given peak, the checking process ends if the spread of the peak is less than the threshold.

If the spread of the peak is greater than the threshold, a portion of the raw signal is analysed which corresponds to a portion of the processed signal including the given peak. This makes it possible to perform a more sensitive analysis as the processed signal has been modified in such a way that small variations in amplitude may have been eliminated. The said portion of the raw signal can advantageously be finely filtered by a filtering operation using a moving average. This makes it possible to remove high-frequency disturbances.

In a step S13 in which the stuck-together items are detected, the point-to-point derivative of that portion of the raw signal which corresponds to the given peak is calculated. In a step S14, the calculated derivative is analysed. If a change in the sign of the derivative of the raw signal which was not detected on the derivative of the processed signal is detected in the raw signal, then it can be considered that there are two stuck-together items present and a counter can be incremented in a step S16. The additional detected peak may have been hidden in the signal processed in the statistical processing operations. The checking process ends after the incrementation step. FIG. 11A illustrates a raw signal 40 which has an additional small-amplitude peak 402.

If no additional peak is detected, a second derivative of that portion of the raw signal which corresponds to the processed signal portion including the given peak is determined in a step S16. The second derivative can be obtained point to point from the derivative calculated in step S13.

If a peak of the second derivative is detected in the said portion of the raw signal at a distance less than the mean value of the spread of a peak of the signal, then it may be considered that two stuck-together items are present and a counter can be incremented in a step S16. Otherwise, the checking process ends. FIG. 11B illustrates a derivative 43 and a second derivative 44 of a raw signal 40 (not shown). The second derivative 44 has a peak 441 corresponding to a point of inflection 431 of the derivative. In one embodiment, a peak of the second derivative can be considered as representing stuck-together letters if the peak is detected at a distance D which is less than approximately half the spread Ea of the abnormal peak. The capture window for the stuck-together letters is thus equal to approximately 50% of the spread of the specific abnormal-spread peak and is centred on the peak. This corresponds to a dispersion factor of four, in other words two times fatter or two times thinner than an average item.

In a third embodiment of the counting step S5, the determination of the number of items 31 in the processed signal 50 includes serial analysis of consecutive quadruplets of points of the processed signal. For a given quadruplet (Xp, Xp+1, Xp+2, Xp+3) the analysis can include the determination of a slope between the two first points (Xp, Xp+1) of the quadruplet and of a slope between the two last points (Xp+2, Xp+3) of the quadruplet. A peak of the processed signal can be determined by a change in the direction of the determined slopes. In a complementary fashion, flat peaks can be identified by identifying high half-peaks and low half-peaks which are apart from one another. The high half-peaks and low half-peaks can be determined respectively on a given quadruplet of points in the processed signal by the transition from a horizontal slope (or a negative one, respectively) for the two first points (Xp, Xp+1) of a quadruplet to a positive slope (or a horizontal one, respectively) for the two last points (Xp+2, Xp+3) of the quadruplet. This makes it possible to identify peaks which are almost flat and have a significant spread.

In one embodiment of the counting step S5, the number of items in the processed signal can be determined successively according to the three above-described embodiments so as to obtain several results for the count of the number of items in the stack.

In one embodiment, the counting method can be carried out several times in succession so as to obtain several results for the count of the number of items in the stack. It is also possible to use a multi-beam range finder or a plurality of range finders in order to obtain a plurality of counting results.

In the embodiments in which several counting results are obtained, the counting step S5 may be followed by a convergence determination step S6 in which at least one disruptive measurement can be removed. Advantageously, the operator of the counting device may be alerted if the counting results have a standard deviation greater than a predetermined tolerated value.

Although it has been described with the aid of a number of exemplary embodiments, the counting method and the device according to the invention comprise various alternative embodiments, modifications and improvements which will be readily apparent to a person skilled in the art, it being understood that these various alternative embodiments, modifications and improvements fall within the scope of the invention as defined in the following claims.

What is claimed:

1. A method for counting stacked items forming on one side of a stack at least one level variation line formed by the edges of the stacked items, the method comprising:
recording a raw signal corresponding to the telemetric measurement of the variation in level on a line of points traversing the side of the stack;
analysing the raw signal in order to estimate one or more parameters relating to the structure of the stack;
processing the recorded raw signal in one or more statistical processing operations on the basis of the estimated parameters; and
analysing the processed signal in order to determine the number of stacked items.

2. The counting method according to claim 1, wherein the estimated parameters include:
a mean thickness of the items in the stack, and
a dispersion factor for the thicknesses of the items in the stack.

3. The counting method according to claim 2, wherein the processing of the raw signal comprises determining an interference threshold proportional to the product of the dispersion factor and the mean thickness.

4. The counting method according to claim 2, wherein the processing of the raw signal comprises determining an interference threshold estimated on the basis of a mean thickness of the items in the stack with a thickness less than a limit thickness.

5. The counting method according to claim 2, wherein the mean thickness is determined as a function of a gross number of stacked items, estimated on the basis of the recorded raw signal.

6. The counting method according to claim 3, wherein the processing of the raw signal comprises eliminating interference peaks on the basis of the interference threshold.

7. The counting method according to claim 3, wherein the step in which the recorded raw signal is processed comprises reconstructing interruptions on the basis of the slope of the signal before and after the interruption when the interruption is longer than the interference threshold.

8. The counting method according to claim 3, wherein the step in which the recorded raw signal is processed comprises reconstructing interruptions on the basis of the value of the signal before and after the interruption when the interruption is shorter than the interference threshold.

9. The counting method according to claim 3, wherein the step in which the recorded raw signal is processed comprises filtering the signal using a moving average, the number of points of the signal on which the said moving average is calculated being determined on the basis of the interference threshold.

10. The counting method according to claim 1, wherein the step in which the processed signal is analysed comprises counting the number of changes in the sign of the derivative of the processed signal and/or counting the number of changes in direction of the processed signal point by point.

11. The counting method according to claim 1, wherein the analysing step comprises checking for the presence of stuck-together items in the stack on the basis of the recorded raw signal.

12. The counting method according to claim 1, wherein the recording step comprises recording a plurality of raw signals corresponding to measurement of the variation in the level on one or more lines of points traversing the whole side of the stack.

13. The counting method according to claim 12, wherein the recording of the plurality of raw signals is performed using a plurality of range finders, a range finder comprising a plurality of beams, and/or by scanning the side of the stack a plurality of times.

14. The counting method according to claim 12, further comprising a step in which the convergence of the results of counting the stacked items which are provided by the plurality of raw signals is checked.

15. A device for counting stacked items comprising:
a telemetric measurement system for measuring a signal corresponding to the variation in level of at least one line traversing a side of the stack formed by the stacked items;
a data storage means for recording the signal; and
a calculation means for implementing the counting method according to claim 1.
